(19) United States
(12) Patent Application Publication
(10) Pub. No.: US 2024/0047987 A1
(43) Pub. Date: Feb. 8, 2024

(54) CIRCUIT DEVICE AND ELECTRONIC APPARATUS

(71) Applicant: SEIKO EPSON CORPORATION, Tokyo (JP)

(72) Inventors: Masaya Ninomiya, Matsumoto-shi (JP); Katsumi Okina, Fujimi-machi (JP)

(21) Appl. No.: 18/360,271

(22) Filed: Jul. 27, 2023

(30) Foreign Application Priority Data
Jul. 29, 2022 (JP) 2022-121300
Sep. 28, 2022 (JP) 2022-154698

(51) Int. Cl. H02J 7/00

(52) U.S. Cl. CPC H02J 7/00714

(57) ABSTRACT

A circuit device includes a current source circuit, a first charging circuit, a second charging circuit, and a control circuit. The control circuit supplies, when a current setting value is in a first current range, a first charging current of a current value indicated by a first setting value from the first charging circuit to a charging node. The control circuit supplies, when the current setting value is in a second current range, a second charging current of a current value indicated by a second setting value from the second charging circuit to the charging node. The control circuit performs at least one of first correction for correcting a first conversion characteristic and second correction for correcting a second conversion characteristic.

The present application is based on, and claims priority from JP Application Serial Numbers 2022-121300 and 2022-154698, filed Jul. 29, 2022 and Sep. 28, 2022, respectively, the disclosures of which are hereby incorporated by reference herein in its entirety.

### BACKGROUND

### 1. Technical Field

The present disclosure relates to a circuit device and an electronic apparatus.

### 2. Related Art

JP-A-10-028338 discloses a charging device that charges a secondary battery from two charging power supplies having different voltages. The voltage of one power supply is slightly lower than a reference voltage when the secondary battery is charged, and the voltage of the other power supply is higher than the reference voltage. The charging device detects a battery voltage, and charges the battery by the two power supplies when the battery voltage is lower than the voltages of the two power supplies. When the secondary battery is charged to a certain extent and the battery voltage exceeds the voltage of the power supply having a lower voltage, the charging device charges the secondary battery only by the power supply having a higher voltage. In JP-A-10-028338, a charging current decreases as the secondary battery is charged, and the charging is ended by detecting the charging current. When the secondary battery is charged to a certain extent, the charging power supply is switched from two to one based on the battery voltage, thereby improving a detection accuracy of the charging current.

In a circuit for charging a battery at a constant current, there is a problem that it is difficult to cope with a large charging current to a small charging current. For example, when a maximum value of the charging current that can be set is increased, a resolution of a current setting decreases or a size of a current source circuit increases.

### SUMMARY

An aspect according to the present disclosure relates to a circuit device including: a current source circuit; a first charging circuit configured to supply, based on an output current of the current source circuit, a first charging current of a constant current as a charging current to a charging node; a second charging circuit configured to supply, based on the output current of the current source circuit, a second charging current of a constant current larger than the first charging current as the charging current to the charging node; and a control circuit configured to perform, based on a current setting value indicating a current value of the charging current, setting value output processing of outputting a first setting value for setting a current value of the first charging current and a second setting value for setting a current value of the second charging current. The control circuit is configured to control, when the current setting value is in a first current range, a first current mode in which the first charging current of the current value indicated by the first setting value is supplied from the first charging circuit to the charging node, control, when the current setting value is in a second current range on a current side higher than the first current range, a second current mode in which the second charging current of the current value indicated by the second setting value is supplied from the second charging circuit to the charging node, and perform, in the setting value output processing, at least one of first correction for correcting a first conversion characteristic of the first charging current with respect to the current setting value by correcting the first setting value and second correction for correcting a second conversion characteristic of the second charging current with respect to the current setting value by correcting the second setting value.

Another aspect according to the present disclosure relates to an electronic apparatus including the above-described circuit device and a battery coupled to the charging node.

### BRIEF DESCRIPTION OF THE DRAWINGS

FIG. 1 shows a configuration example of a circuit device and an electronic apparatus according to a first embodiment.

FIG. 2 shows a characteristic example of a first charging current and a second charging current before correction.

FIG. 3 shows a detailed configuration example of a control circuit and a storage unit.

FIG. 4 is an operation explanatory diagram of the control circuit according to the first embodiment.

FIG. 5 is a diagram showing a correction method.

FIG. 6 shows an example of offset correction.

FIG. 7 shows an example of the offset correction.

FIG. 8 shows an example of the offset correction.

FIG. 9 shows an example of the offset correction.

FIG. 10 shows an example of slope correction.

FIG. 11 shows an example of the slope correction.

FIG. 12 shows an example of the slope correction.

FIG. 13 shows an example of the slope correction.

FIG. 14 shows an example of threshold setting.

FIG. 15 shows a detailed configuration example of a first charging circuit and a second charging circuit.

FIG. 16 shows a detailed configuration example of a current source circuit according to the first embodiment.

FIG. 17 is a diagram showing resistance ratios and operations of the current source circuit according to the first embodiment.

FIG. 18 shows an example of parameters of the first charging circuit, the second charging circuit, and the current source circuit.

FIG. 19 shows a configuration example of a circuit device and an electronic apparatus according to a second embodiment.

FIG. 20 is an operation explanatory diagram of a control circuit according to the second embodiment.

FIG. 21 shows a detailed configuration example of a first charging circuit and a first current source circuit.

FIG. 22 shows a detailed configuration example of a second charging circuit and a second current source circuit.

FIG. 23 is a diagram showing resistance ratios and operations of the first current source circuit and the second current source circuit.

### DESCRIPTION OF EMBODIMENTS

Hereinafter, preferred embodiments according to the present disclosure will be described in detail. The embodiments to be described below do not unduly limit contents described in the claims, and all configurations described in the embodiment are not necessarily essential constituent elements.

### 1. First Embodiment

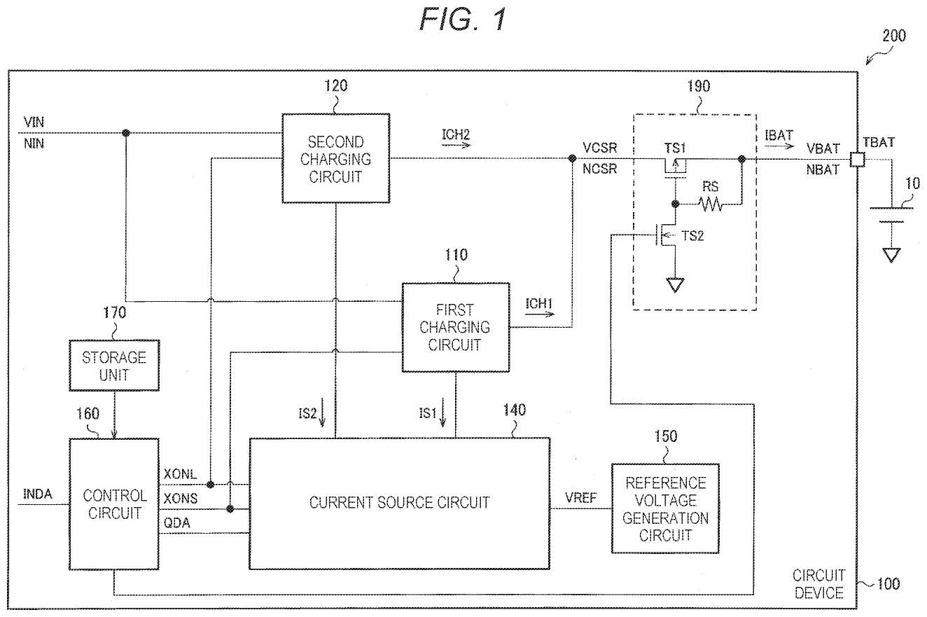

FIG. 1 shows a configuration example of a circuit device 100 and an electronic apparatus 200 including the circuit device 100 according to a first embodiment.

The electronic apparatus 200 includes the circuit device 100 and a battery 10. The battery 10 is a secondary battery, and is, for example, a lithium-ion secondary battery, a nickel-hydrogen storage battery, or a nickel-cadmium storage battery. The electronic apparatus 200 may be any apparatus as long as the apparatus incorporates or can be attached to the battery 10. Examples of the electronic apparatus 200 include a smartphone, a tablet terminal, a wireless earphone, a wireless hearing aid, a smart watch, a digital camera, and a mobile battery. When the electronic apparatus 200 is a smartphone or the like, the electronic apparatus 200 may include a processing device, a storage device, a wireless communication device, a display device, an operation input device, and the like.

The circuit device 100 charges the battery 10 based on a power supply supplied from an outside. The circuit device 100 includes a first charging circuit 110, a second charging circuit 120, a current source circuit 140, a reference voltage generation circuit 150, a control circuit 160, a storage unit 170, a backflow prevention circuit 190, and a terminal TBAT. The circuit device 100 is, for example, an integrated circuit device in which a plurality of circuit elements are integrated on a semiconductor substrate.

The backflow prevention circuit 190 is provided between an output node NCSR of the first charging circuit 110 and the second charging circuit 120 and a charging node NBAT coupled to the terminal TBAT. A terminal of the battery 10 is coupled to the terminal TBAT. When the control circuit 160 turns on the backflow prevention circuit 190, a first charging current ICH1 from the first charging circuit 110 or a second charging current ICH2 from the second charging circuit 120 is supplied to the charging node NBAT as a charging current IBAT. When the charging current IBAT is supplied from the terminal TBAT to the battery 10, the battery 10 is charged.

The backflow prevention circuit 190 includes a P-type transistor TS1, an N-type transistor TS2, and a resistor RS. A source of the P-type transistor TS1 is coupled to the charging node NBAT, and a drain of the P-type transistor TS1 is coupled to the output node NCSR. A source of the N-type transistor TS2 is coupled to a ground node, and a drain of the N-type transistor TS2 is coupled to a gate of the P-type transistor TS1. One end of the resistor RS is coupled to the charging node NBAT, and the other end of the resistor RS is coupled to the gate of the P-type transistor TS1. When the control circuit 160 turns off the N-type transistor TS2, the P-type transistor TS1 is turned off. Since the P-type transistor TS1 includes a parasitic diode using a direction from the output node NCSR to the charging node NBAT as a forward direction, when the P-type transistor TS1 is turned off, the backflow prevention circuit 190 prevents backflow from the battery 10 to the first charging circuit 110 and the second charging circuit 120. When the battery 10 is charged, the control circuit 160 turns on the N-type transistor TS2. Accordingly, the P-type transistor TS1 is turned on. Hereinafter, a charging operation when the P-type transistor TS1 of the backflow prevention circuit 190 is turned on will be mainly described.

The control circuit 160 controls, based on a current setting value INDA indicating a setting value of a charging current, the charging such that the battery 10 is charged at a current value indicated by the current setting value INDA. The current setting value INDA may be input from, for example, a processing device provided outside the circuit device 100, or the control circuit 160 may set the current setting value INDA based on a detection result from a detection circuit (not shown) that detects a battery voltage VBAT.

The control circuit 160 switches, based on the current setting value INDA, between a first charging mode in which the first charging circuit 110 charges the battery 10 and a second charging mode in which the second charging circuit 120 charges the battery 10. Specifically, when the current setting value INDA is less than a threshold, the control circuit 160 activates a first enable signal XONS to perform first correction of the first current mode on the current setting value INDA, and outputs a result of the correction as a current source control value QDA to the current source circuit 140. When the current setting value INDA is equal to or greater than the threshold, the control circuit 160 activates a second enable signal XONL to perform second correction of the second current mode on the current setting value INDA, and outputs a result of the correction as the current source control value QDA to the current source circuit 140. However, only one of the first correction and the second correction may be performed, or both may be performed. Details of the first correction and the second correction will be described later.

The storage unit 170 stores correction parameters of the first correction and the second correction and the threshold of the current setting value INDA. The control circuit 160 performs the first correction and the second correction based on the correction parameters read from the storage unit 170. Further, the control circuit 160 switches between the first current mode and the second current mode based on the threshold read from the storage unit 170. The storage unit 170 is a memory, a register, or the like. The memory is, for example, a nonvolatile memory or a RAM. In addition, the memory may be a combination of a nonvolatile memory and a register, or may be a fuse, an external circuit of the circuit device 100, or the like as long as the memory can store data. When the storage unit 170 is a nonvolatile memory, for example, the threshold and the correction parameters are written into the storage unit 170 at a time of manufacturing the circuit device 100 or the electronic apparatus 200. When the storage unit 170 is a RAM or a register, for example, the threshold and the correction parameters are written into the storage unit 170 from the processing device outside the circuit device 100 via an interface circuit (not shown).

The reference voltage generation circuit 150 generates a reference voltage VREF. The reference voltage generation circuit 150 is, for example, a bandgap reference circuit, but is not limited thereto. The reference voltage VREF may be supplied from an outside of the circuit device 100.

The current source circuit 140 supplies, based on the reference voltage VREF, an output current set by the current source control value QDA to the first charging circuit 110 and the second charging circuit 120. Specifically, when the first enable signal XONS is active, the current source circuit 140 supplies a first current IS1 as the output current to the first charging circuit 110. When the second enable signal XONL is active, the current source circuit 140 supplies a second current IS2 as the output current to the second charging circuit 120.

A power supply voltage VIN is supplied to a power supply node NIN. The power supply voltage VIN is supplied from, for example, an external power supply of the circuit device 100. Alternatively, the circuit device 100 may include a power-receiving circuit or a voltage conversion circuit (not shown) that receives electric power from the external power supply and outputs the power supply voltage VIN.

When the first enable signal XONS is active, the first charging circuit 110 outputs the first charging current ICH1 to the output node NCSR based on the power supply voltage VIN and the first current IS1. Specifically, the first charging circuit 110 amplifies the first current IS1 with a first gain, and outputs the amplified current as the first charging current ICH1.

When the second enable signal XONL is active, the second charging circuit 120 outputs the second charging current ICH2 to the output node NCSR based on the power supply voltage VIN and the second current IS2. Specifically, the second charging circuit 120 amplifies the second current IS2 with a second gain, and outputs the amplified current as the second charging current ICH2. A current value of the second charging current ICH2 is larger than a current value of the first charging current ICH1. That is, ICH1<Ith≤ICH2, in which a threshold of the charging current IBAT corresponding to the threshold of the current setting value INDA is Ith.

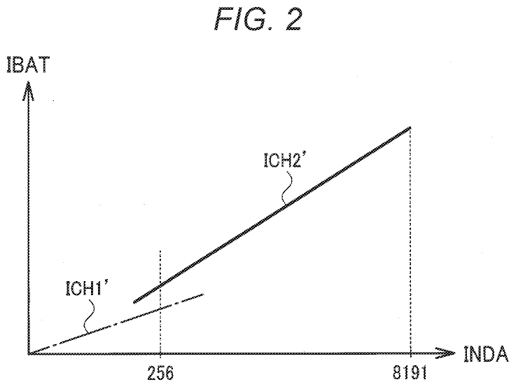

Hereinafter, the first correction and the second correction will be described. First, a reason for performing the correction will be described with reference to FIG. 2. FIG. 2 shows a characteristic example of a first charging current ICH1′ before the correction and a second charging current ICH2′ before the correction. Here, the threshold of the current setting value INDA is 256, and a maximum value of the current setting value INDA is 8191.

When INDA<256, the first charging circuit 110 outputs IBAT=ICH1′, and when 256≤INDA≤8191, the second charging circuit 120 outputs IBAT=ICH2′. A conversion characteristic from the current setting value INDA to the first charging current ICH1′ is referred to as a first conversion characteristic, and a conversion characteristic from the current setting value INDA to the second charging current ICH2′ is referred to as a second conversion characteristic. At this time, switching between the first charging circuit 110 and the second charging circuit 120 may cause a characteristic difference between the first conversion characteristic and the second conversion characteristic. The characteristic difference is an offset difference, a slope difference, or both the offset difference and the slope difference. For example, when the first gain when the first charging circuit 110 amplifies the first current IS1 or the second gain when the second charging circuit 120 amplifies the second current IS2 deviates from an ideal value due to a parasitic resistance or the like, the characteristic difference occurs between the first conversion characteristic and the second conversion characteristic. Alternatively, since a characteristic difference occurs between a characteristic of the first current IS1 with respect to the current setting value INDA and a characteristic of the second current IS2 with respect to the current setting value INDA, the characteristic difference occurs between the first conversion characteristic and the second conversion characteristic.

In the embodiment, the control circuit 160 corrects the characteristic difference between the first conversion characteristic and the second conversion characteristic by performing at least one of the first correction and the second correction for the current setting value INDA. Hereinafter, a correction method will be described in detail.

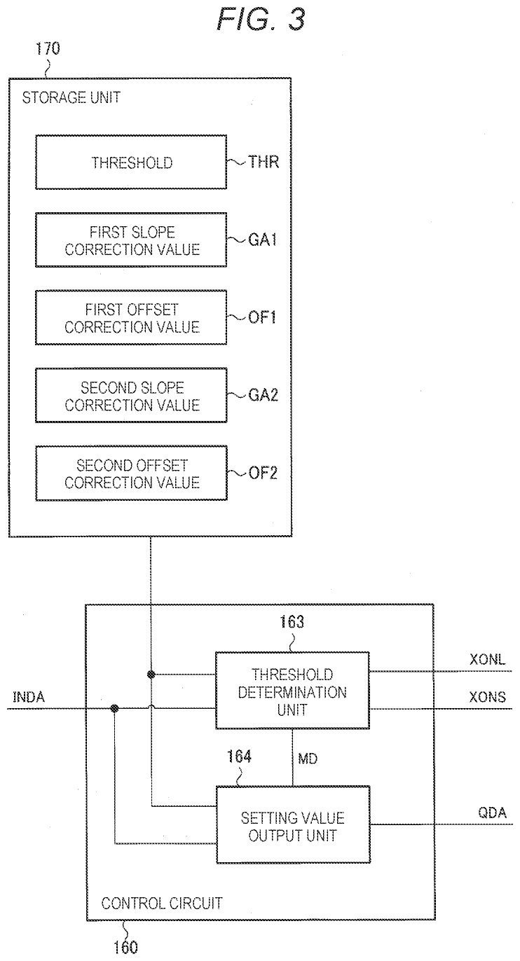

FIG. 3 shows a detailed configuration example of the control circuit 160 and the storage unit 170. The control circuit 160 includes a threshold determination unit 163 and a setting value output unit 164. The storage unit 170 stores a threshold THR of the current setting value INDA. The storage unit 170 stores a first slope correction value GA1 and a first offset correction value OF1, which are correction parameters of the first correction. The storage unit 170 further stores a second slope correction value GA2 and a second offset correction value OF2, which are correction parameters of the second correction. The correction parameters of the first correction and the second correction stored in the storage unit 170 are not limited to the first slope correction value GA1, the first offset correction value OF1, the second slope correction value GA2, and the second offset correction value OF2. Alternatively, correction parameters related thereto may be stored in the storage unit 170 as correction parameters.

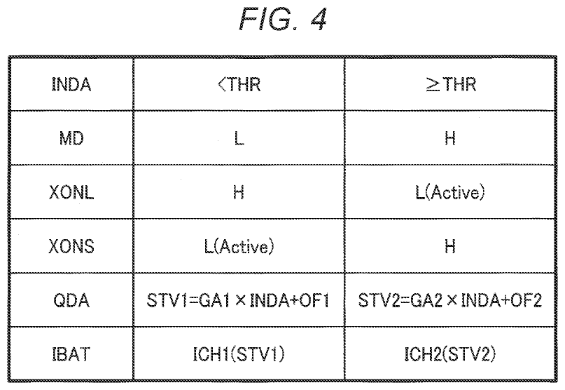

FIG. 4 is an operation explanatory diagram of the control circuit 160 according to the first embodiment.

The threshold determination unit 163 compares the current setting value INDA with the threshold THR. The threshold determination unit 163 outputs a low-level mode control signal MD indicating the first current mode when the current setting value INDA is less than the threshold THR, and outputs a high-level mode control signal MD indicating the second current mode when the current setting value INDA is equal to or greater than the threshold THR. The threshold determination unit 163 may output the low-level mode control signal MD indicating the first current mode when the current setting value INDA is equal to or less than the threshold THR, and may output the high-level mode control signal MD indicating the second current mode when the current setting value INDA is larger than the threshold THR. Correspondence between a current mode and a logic level of the mode control signal MD is not limited to the above.

When the mode control signal MD is at a low level, the threshold determination unit 163 outputs the first enable signal XONS at a low level and the second enable signal XONL at a high level. Here, low active is assumed to be used. When the mode control signal MD is at a high level, the threshold determination unit 163 outputs the first enable signal XONS at a high level and the second enable signal XONL at a low level.

The setting value output unit 164 performs the first correction for obtaining a first setting value STV1=GA1×INDA+OF1 and the second correction for obtaining a second setting value STV2=GA2×INDA+OF2. The first setting value STV1 is obtained by adding the first offset correction value OF1 to a product of the first slope correction value GA1 and the current setting value INDA, and the second setting value STV2 is obtained by adding the second offset correction value OF2 to a product of the second slope correction value GA2 and the current setting value INDA. When the mode control signal MD is at a low level, the setting value output unit 164 outputs the current source control value QDA based on the first setting value STV1. Accordingly, the charging current IBAT=ICH1 in the first charging mode is controlled by the first setting value STV1 corrected by the first correction. When the mode control signal MD is at a high level, the setting value output unit 164 outputs the current source control value QDA based on the second setting value STV2. Accordingly, the charging current IBAT=ICH2 in the second charging mode is controlled by the second setting value STV2 corrected by the second correction.

The correction parameters are determined, for example, as follows. In an inspection process of the circuit device 100 or simulation processing at a time of designing the circuit device 100, a slope value and an offset value of the ICH1′ and a slope value and an offset value of the ICH2′ in FIG. 2 are measured. The first slope correction value GA1 is, for example, a value obtained by dividing a target slope value by the measured slope value of the ICH1′. The first offset correction value OF1 is a value obtained by subtracting the measured offset value of the ICH1′ from a target offset value. The same applies to a method of determining the second slope correction value GA2 and the second offset correction value OF2. However, the above-described method is an example, and a method of determining the correction parameter is not limited thereto.

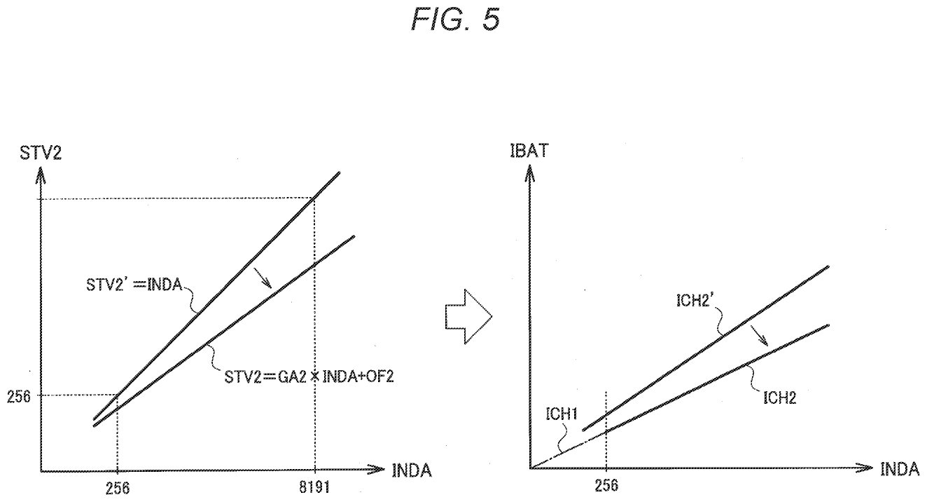

FIG. 5 is a diagram showing the correction method. A left part of FIG. 5 shows a conversion characteristic from the current setting value INDA to the second setting value STV2. A right part of FIG. 5 shows a conversion characteristic from the current setting value INDA to the charging current IBAT. Here, an example in which only the second correction is performed will be described, but only the first correction may be performed, or the first correction and the second correction may be performed.

As shown in the left part, when the second correction is not performed, the second setting value is STV2′=INDA, and as shown in the right part, a characteristic difference occurs between the conversion characteristic from the current setting value INDA to the first charging current ICH1 and the conversion characteristic from the current setting value INDA to the second charging current ICH2′. According to the embodiment, as shown in the left part, since the second setting value is corrected to STV2=GA2×INDA+OF2 by performing the second correction, a conversion characteristic from the current setting value INDA to the second charging current ICH2 is corrected as shown in the right part. Accordingly, a characteristic difference between the conversion characteristic from the current setting value INDA to the first charging current ICH1 and the conversion characteristic from the current setting value INDA to the second charging current ICH2 is reduced.

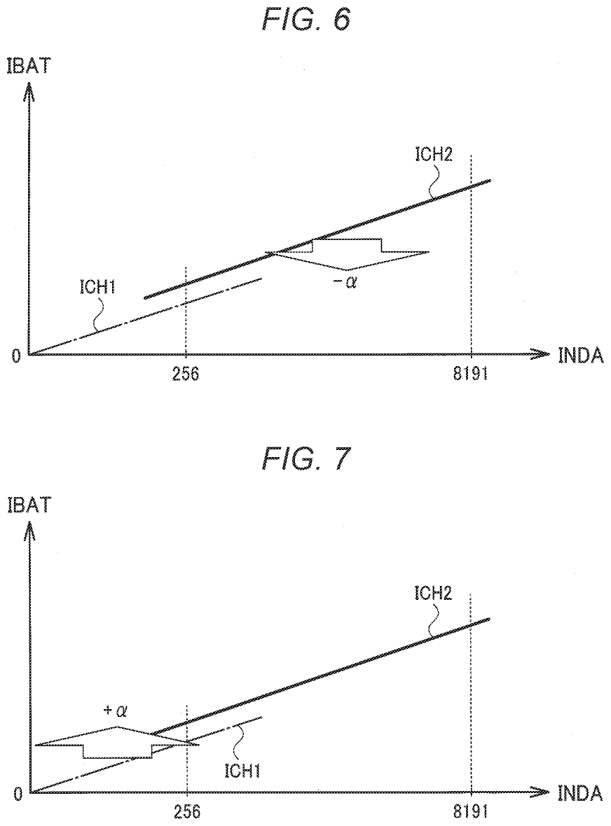

FIGS. 6 to 9 are examples of offset correction. In FIGS. 6 to 9, a is a positive value. Actually, the offset correction is performed on the first setting value STV1 or the second setting value STV2, and the offset correction performed on the first charging current ICH1 or the second charging current ICH2 as a result is shown in FIGS. 6 to 9.

As shown in FIG. 6, when a conversion characteristic of the second charging current ICH2 has a positive offset with respect to a conversion characteristic of the first charging current ICH1, the setting value output unit 164 corrects the conversion characteristic of the second charging current ICH2 with the second offset correction value OF2C=−α, which is negative. Alternatively, as shown in FIG. 7, the setting value output unit 164 corrects the conversion characteristic of the first charging current ICH1 with the first offset correction value OF1=+α, which is positive.

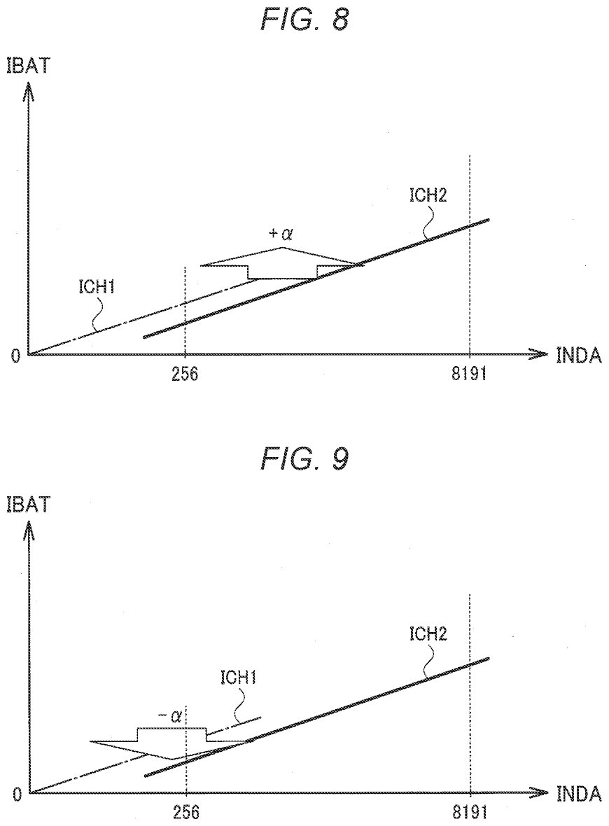

As shown in FIG. 8, when the conversion characteristic of the second charging current ICH2 has a negative offset with respect to the conversion characteristic of the first charging current ICH1, the setting value output unit 164 corrects the conversion characteristic of the second charging current ICH2 with the second offset correction value OF2=+α, which is positive. Alternatively, as shown in FIG. 9, the setting value output unit 164 corrects the conversion characteristic of the first charging current ICH1 with the first offset correction value OF1=−α, which is negative.

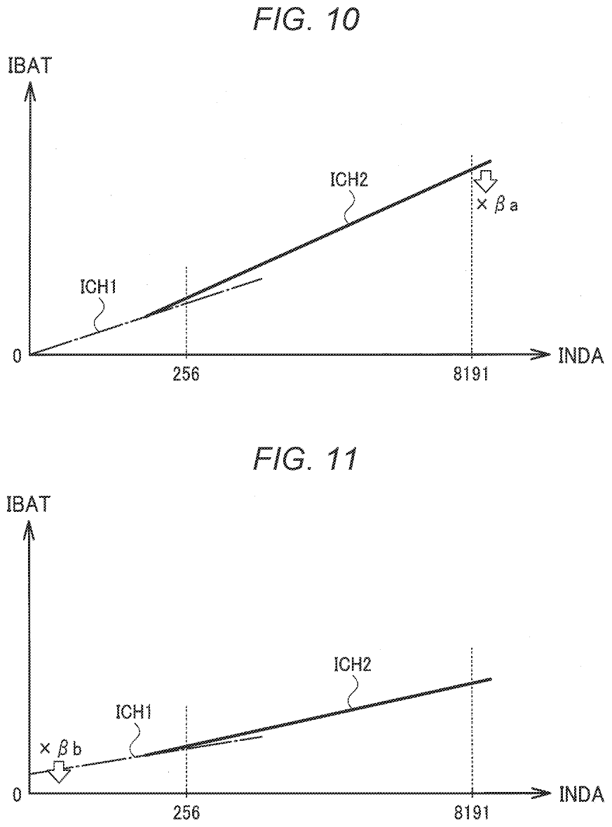

FIGS. 10 to 13 show examples of slope correction. In FIGS. 10 to 13, βa is a positive value smaller than 1, and βb is a value larger than 1. Actually, the slope correction is performed on the first setting value STV1 or the second setting value STV2, and the slope correction performed on the first charging current ICH1 or the second charging current ICH2 as a result is shown here.

As shown in FIG. 10, when a slope of the conversion characteristic of the second charging current ICH2 is larger than a slope of the conversion characteristic of the first charging current ICH1, the setting value output unit 164 corrects the conversion characteristic of the second charging current ICH2 with the second slope correction value GA2=βa smaller than 1. Alternatively, as shown in FIG. 11, the setting value output unit 164 corrects the conversion characteristic of the first charging current ICH1 with the first slope correction value GA1=βb larger than 1.

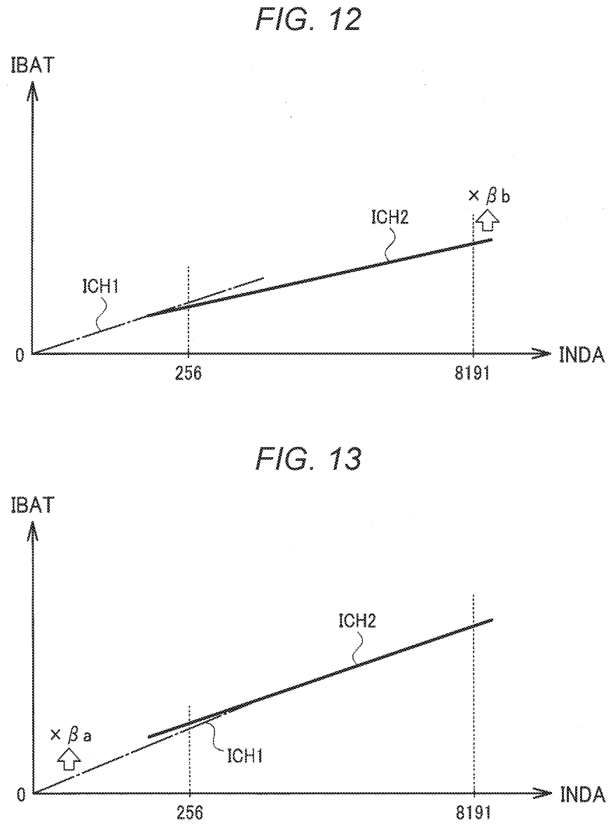

As shown in FIG. 12, when the slope of the conversion characteristic of the second charging current ICH2 is smaller than the slope of the conversion characteristic of the first charging current ICH1, the setting value output unit 164 corrects the conversion characteristic of the second charging current ICH2 with the second slope correction value GA2=βb larger than 1. Alternatively, as shown in FIG. 13, the setting value output unit 164 corrects the conversion characteristic of the first charging current ICH1 with the first slope correction value GA1=βa smaller than 1.

The setting value output unit 164 may correct the first charging current ICH1, the second charging current ICH2, or the first charging current ICH1 and the second charging current ICH2 by combining two or more types of correction among the correction described in FIGS. 6 to 13.

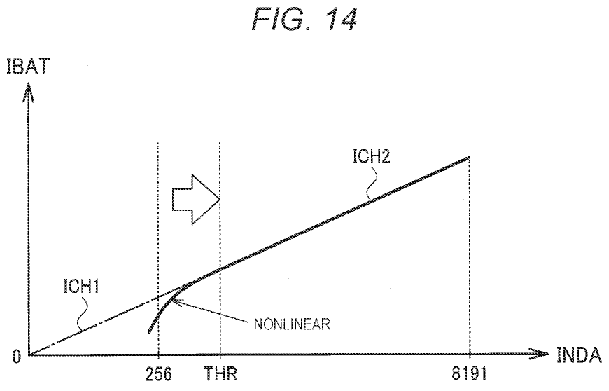

FIG. 14 is an example of threshold setting. For example, when a reference of the threshold THR is 256, the threshold THR can be variably set in a range of ±1 bit of the current setting value INDA around the reference, that is, in a range of 128 to 511. However, an adjustment range of the threshold THR may be freely set.

As shown in FIG. 14, for example, there is a region where the current value is nonlinear with respect to the current setting value INDA on a low current side of the second charging current ICH2. For example, when the second current IS2 becomes low current and an operational amplifier or a transistor in the second charging circuit 120 does not operate normally, the nonlinear region occurs. At this time, the threshold THR is set to a value larger than the reference which is 256 such that a charging mode is switched in a linear region of the second charging current ICH2. The threshold THR may be set to a value smaller than the reference which is 256. For example, when there is a region where the current value is nonlinear with respect to the current setting value INDA on a high current side of the first charging current ICH1, the threshold THR may be set to a value smaller than the reference which is 256.

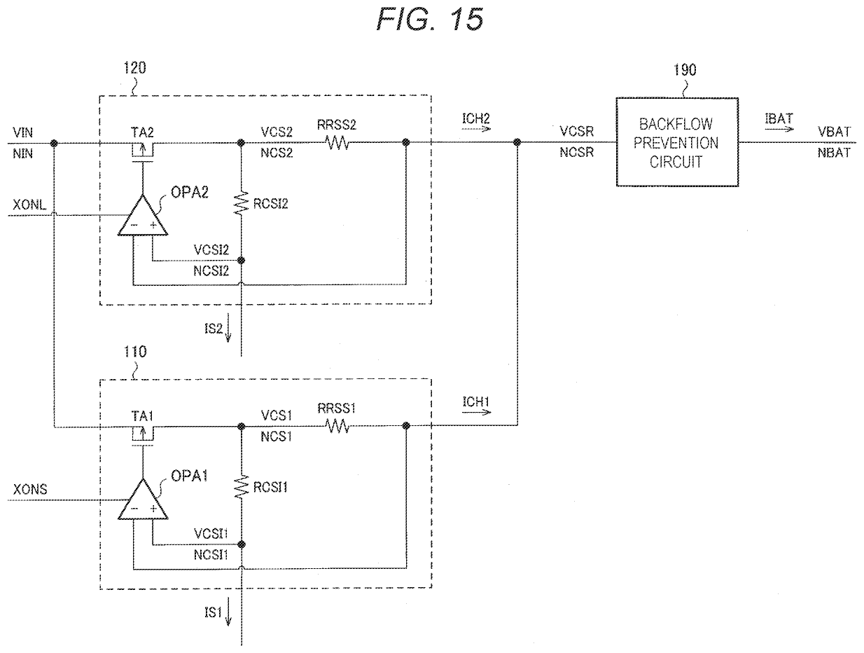

Hereinafter, detailed configuration examples and operations of the first charging circuit 110, the second charging circuit 120, and the current source circuit 140 will be described. FIG. 15 shows the detailed configuration example of the first charging circuit 110 and the second charging circuit 120.

The first charging circuit 110 includes an operational amplifier OPAL, a P-type transistor TA1, a resistor RCSI1, and a resistor RRSS1.

A source of the P-type transistor TA1 is coupled to the power supply node NIN, and a drain of the P-type transistor TA1 is coupled to a node NCS1. The power supply voltage VIN is supplied to the power supply node NIN. One end of the resistor RCSI1 is coupled to the node NCS1, and the other end of the resistor RCSI1 is coupled to a node NCSI1. One end of the resistor RRSS1 is coupled to the node NCS1, and the other end of the resistor RRSS1 is coupled to the output node NCSR. A non-inverting input terminal of the operational amplifier OPAL is coupled to the node NCSI1, an inverting input terminal of the operational amplifier OPAL is coupled to the output node NCSR, and an output node thereof is coupled to a gate of the P-type transistor TA1.

The operational amplifier OPAL is enabled when the first enable signal XONS is active. Accordingly, the first charging current ICH1={(RCSI1/RRSS1)×IS1} is supplied to the output node NCSR and supplied to the charging node NBAT as the charging current IBAT.

The second charging circuit 120 includes an operational amplifier OPA2, a P-type transistor TA2, a resistor RCSI2, and a resistor RRSS2.

A source of the P-type transistor TA2 is coupled to the power supply node NIN, and a drain of the P-type transistor TA2 is coupled to a node NCS2. One end of the resistor RCSI2 is coupled to the node NCS2, and the other end of the resistor RCSI2 is coupled to a node NCSI2. One end of the resistor RRSS2 is coupled to the node NCS2, and the other end of the resistor RRSS2 is coupled to the output node NCSR. A non-inverting input terminal of the operational amplifier OPA2 is coupled to the node NCSI2, an inverting input terminal of the operational amplifier OPA2 is coupled to the output node NCSR, and an output node thereof is coupled to a gate of the P-type transistor TA2.

The operational amplifier OPA2 is enabled when the second enable signal XONL is active. Accordingly, the second charging current ICH2=(RCSI2/RRSS2)×IS2 is supplied to the output node NCSR and supplied to the charging node NBAT as the charging current IBAT.

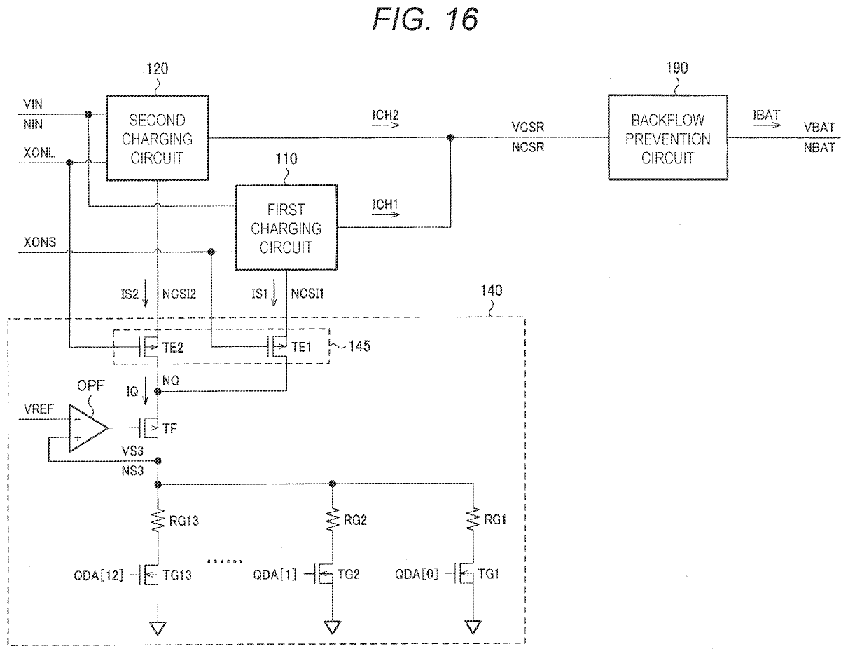

FIG. 16 is the detailed configuration example of the current source circuit 140 according to the first embodiment. The current source circuit 140 includes an operational amplifier OPF, a switch circuit 145, a P-type transistor TF, resistors RG1 to RG13, and N-type transistors TG1 to TG13.

The switch circuit 145 includes P-type transistors TE1 and TE2. A source of the P-type transistor TE1 is coupled to the node NCSI1, and a drain of the P-type transistor TE1 is coupled to a node NQ. A source of the P-type transistor TE2 is coupled to the node NCSI2, and a drain of the P-type transistor TE2 is coupled to the node NQ. When the first enable signal XONS is at a low level, the P-type transistor TE1 is turned on, and a current IQ flowing through the P-type transistor TF flows to the node NCSI1 as the first current IS1. When the second enable signal XONL is at a low level, the P-type transistor TE2 is turned on, and the current IQ flowing through the P-type transistor TF flows to the node NCSI2 as the second current IS2.

A source of the P-type transistor TF is coupled to the node NQ, and a drain of the P-type transistor TF is coupled to a node NS3. The reference voltage VREF is input to an inverting input terminal of the operational amplifier OPF. A non-inverting input terminal of the operational amplifier OPF is coupled to the node NS3, and an output node of the operational amplifier OPF is coupled to a gate of the P-type transistor TF. One end of the resistor RG1 is coupled to the node NS3, and the other end of the resistor RG1 is coupled to a drain of the N-type transistor TG1. A source of the N-type transistor TG1 is coupled to the ground node. Similarly, one end of each of the resistors RG2 to RG13 is coupled to the node NS3, and the other end of each of the resistors RG2 to RG13 is coupled to a drain of a respective one of the N-type transistors TG2 to TG13. A source of each of the N-type transistors TG2 to TG13 is coupled to the ground node. Hereinafter, a bit signal of the current source control value QDA is referred to as a control bit signal. A control bit signal QDA[0] of the current source control value QDA is input to a gate of the N-type transistor TG1. Similarly, control bit signals QDA[1] to QDA[12] of the current source control value QDA are input to gates of the N-type transistors TG2 to TG13.

The operational amplifier OPF is enabled in both the first current mode and the second current mode, and a voltage of the node NS3 is VS3=VREF. The resistor RG1 and the N-type transistor TG1 are referred to as a first current source of the current source circuit 140. When the control bit signal QDA[0] of the current source control value QDA is 1, the N-type transistor TG1 is turned on, and the first current source causes a current of VREF/RG1 to flow. Similarly, the resistors RG2 to RG13 and the N-type transistors TG2 to TG13 are referred to as second to thirteenth current sources of the current source circuit 140. When the control bit signals QDA[1] to QDA[12] of the current source control value QDA are 1, the N-type transistors TG2 to TG13 are turned on, and the second to thirteenth current sources cause currents of VREF/RG2 to VREF/RG13 to flow. The current IQ flowing through the P-type transistor TF is a sum of the currents flowing from the current sources corresponding to the control bit signal which is 1 among the control bit signals QDA[0] to QDA[12] of the current source control value QDA.

Here, the number of current sources included in the current source circuit 140 is 13, and the number of current sources included in the current source circuit 140 may be n. n is an integer of 2 or more.

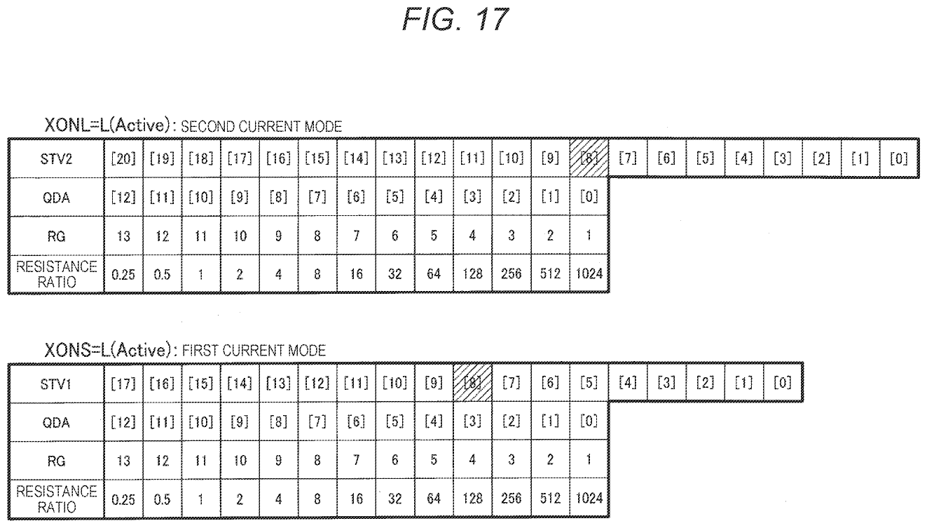

FIG. 17 is a diagram showing resistance ratios and operations of the current source circuit 140 according to the first embodiment.

A resistance ratio of the resistors RG1 to RG13 for determining a current ratio of the first to thirteenth current sources is RG13:RG12 . . . :RG2:RG1=0.25:0.5 . . . :512:1024. Since a reciprocal ratio thereof is the current ratio, the currents flowing from the first to thirteenth current sources are binarily weighted.

The setting value output unit 164 corrects the current setting value INDA to obtain the first setting value STV1 and the second setting value STV2. At this time, the first setting value STV1 and the second setting value STV2 are calculated with accuracy higher than an LSB of the current setting value INDA. For example, when the current setting value INDA is 13-bit INDA[12:0], the first setting value STV1 is calculated as 18-bit STV1[17:0], and the second setting value STV2 is calculated as 21-bit STV2[20:0]. At this time, a bit corresponding to INDA[0] which is the LSB of the current setting value is STV1[8] in STV1[17:0] and STV2[8] in STV2[20:0]. For example, when the first correction is not performed, STV1[17:8]=INDA[9:0], and thus STV1[8]=INDA[0]. When the second correction is not performed, STV2[20:8]=INDA[12:0], and thus STV2[8]=INDA[0].

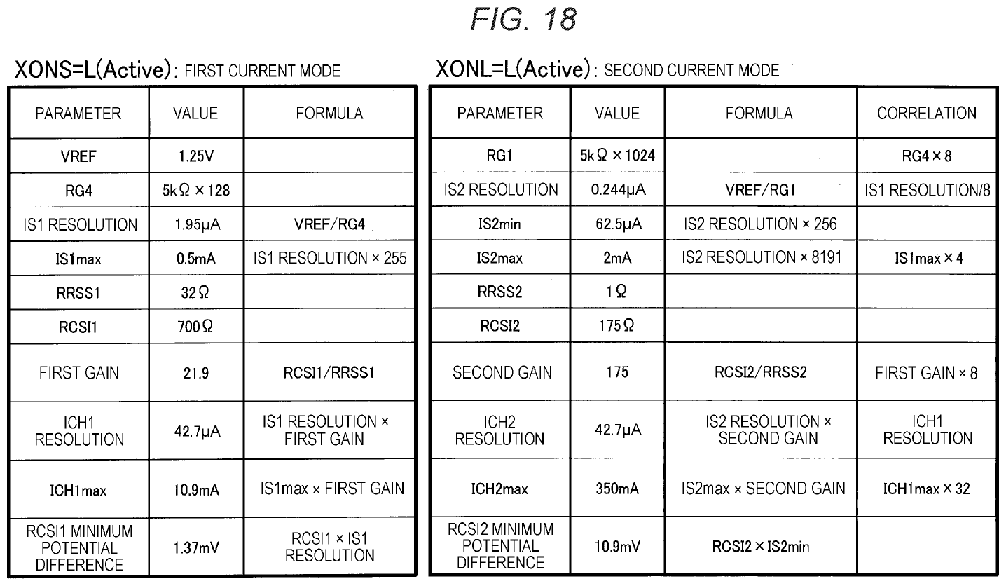

In a case of the first current mode, that is, when the first enable signal XONS is at a low level, the setting value output unit 164 assigns upper 13 bits of STV1[17:0] to the current source control value QDA, and outputs QDA[12:0]=STV1[17:5] to the current source circuit 140. In a case of the second current mode, that is, when the second enable signal XONL is at a low level, the setting value output unit 164 assigns upper 13 bits of STV2[20:0] to the current source control value QDA, and outputs QDA[12:0]=STV2[20:8] to the current source circuit 140. In QDA[12:0], the bit corresponding to INDA[0] which is the LSB of the current setting value is QDA[3] in the first current mode and QDA[0] in the second current mode. That is, a resolution of the first current IS1 and a resolution of the second current IS2 corresponding to the LSB of the current setting value INDA are different. Since the difference is absorbed by a difference between the first gain of the first charging circuit 110 and the second gain of the second charging circuit 120, the resolution of the first charging current ICH1 corresponding to the LSB of the current setting value INDA and the resolution of the second charging current ICH2 corresponding to the LSB of the current setting value INDA are substantially equal. This point will also be described in FIG. 18.

Here, an example is shown in which the first setting value STV1 and the second setting value STV2 extended by 8 bits to a lower side with respect to the current setting value INDA are calculated. However, the number of bits for the extension may be freely set as long as an accuracy required for the calculation can be ensured. Here, an example is shown in which the assignment from the first setting value STV1 to the current source control value QDA and the assignment from the second setting value STV2 to the current source control value QDA are shifted by three bits. However, the number of bits for the shift may be freely set within a range in which the first charging current ICH1 and the second charging current ICH2 can have the same resolution according to a correlation between the first gain and the second gain.

A left part of FIG. 18 is an example of parameters of the first charging circuit 110 and the current source circuit 140 in the first current mode, and a right part of FIG. 18 is an example of parameters of the second charging circuit 120 and a second current source circuit 142 in the second current mode. The right part of FIG. 18 also shows a correlation with the parameters in the left part. FIG. 18 shows an ideal parameter example, that is, a parameter example in which ideal characteristics of the first charging current and the second charging current can be obtained even when the correction is not performed.

The reference voltage is set to VREF=1.25 V, a unit resistance of each of the resistors RG1 to RG13 is set to 5 kΩ, and the threshold for switching the current mode is set to 256. In the following description, rounded numerical values will be described as appropriate.

As shown in the left part, a resistance of the fourth current source corresponding to the LSB of the current setting value INDA in the first current mode is RG4=5 kΩ×128. Therefore, the resolution of the first current IS1 corresponding to the LSB of the current setting value INDA is VREF/RG4=1.95 μA. A maximum value IS1max of the first current is (IS1 resolution)×255=0.5 mA. When RRSS1=32Ω and RCSI11=700Ω, the first gain is RCSI1/RRSS1=21.9. The resolution of the first charging current ICH1 becomes (IS1 resolution)×(first gain)=42.7 μA, and a maximum value ICH1max of the first charging current becomes IS1max×(first gain)=10.9 mA. A minimum potential difference between both ends of the resistor RCSI1 becomes RCSI1×(IS1 resolution)=1.37 mV.

As shown in the right part, a resistance of the first current source corresponding to the LSB of the current setting value INDA in the second current mode is RG1=5 kΩ×1024. Therefore, the resolution of the second current IS2 corresponding to the LSB of the current setting value INDA becomes VREF/RD1=0.244 μA. When QDA[12:0]=0000100000000, the second current takes a minimum value IS2min=(IS2 resolution)×256=62.5 μA. A maximum value IS2max of the second current is (IS2 resolution)×8191=2 mA. When RRSS2=1Ω and RCSI12=175Ω are assumed, the second gain is RCSI2/RRSS2=175. The resolution of the second charging current ICH2 becomes (IS2 resolution)×(second gain)=42.7 μA, and the maximum value ICH2max of the second charging current becomes IS2max×(second gain)=350 mA. A minimum potential difference between both ends of the resistor RCSI2 becomes RCSI2×IS2min=10.9 mV. The correlation with the parameters in the left part is as shown. [0085] A minimum value of the second charging current ICH2 is as follows.

$$IS 2 min \times ( second gain ) \\ = \{ ( ( IS 1 resolution ) / 8 ) \times 256 \} \times ( ( first gain ) \times 8 ) \\ = ( IS 1 resolution ) \times 256 \times ( first gain ) \\ = IS 1 max + ( IS 1 resolution ) \times ( first gain )$$

IS1max×(first gain) is a maximum value of the first charging current ICH1, and the (IS1 resolution)×(first gain) is an ICH1 resolution. Further, the ICH1 resolution=ICH2 resolution. That is, a value obtained by increasing the maximum value of the ICH1 by the ICH2 resolution is the minimum value of the ICH2. That is, even before and after the switching between the ICH1 and the ICH2, ideally, the charging current IBAT is linear with respect to the current setting value INDA[12:0].

However, actually manufactured circuits do not have ideal characteristics due to various factors. For example, it is assumed that the resistor RRSS1 of the first charging circuit 110 and the resistor RRSS2 of the second charging circuit 120 both increase by 0.1Ω due to the parasitic resistance. At this time, the first gain is 700Ω/(32 Ω+0.1Ω)=21.8, and the second gain is 175Ω/(1 Ω+0.1Ω)=159. The second gain=7.30×the first gain, which deviates from the ideal correlation of the second gain=8×the first gain. Since the first gain and the second gain are increased to reduce the first current IS1 and the second current IS2 from a viewpoint of charging efficiency, the first gain and the second gain are easily affected by the parasitic resistance. Alternatively, a current supplied by the fourth current source corresponding to the LSB of the current setting value INDA in the first current mode is ideally eight times larger than a current supplied by the first current source corresponding to the LSB of the current setting value INDA in the second current mode. However, when the current supplied by the fourth current source corresponding to the LSB of the current setting value INDA in the first current mode is not actually eight times larger than the current supplied by the first current source corresponding to the LSB of the current setting value INDA in the second current mode due to the influence of the parasitic resistance or the like, the IS1 resolution is not eight times larger than the IS2 resolution.

Due to such a manufacturing error, an offset difference or a slope difference occurs between the first charging current ICH1 and the second charging current ICH2. According to the embodiment, the characteristic difference between the first charging current ICH1 and the second charging current ICH2 can be reduced by performing at least one of the first correction and the second correction described in FIGS. 2 to 13.

In FIG. 18, when the first gain is smaller than the second gain, since the IS1 resolution can be made larger than the IS2 resolution, a minimum potential difference of the resistor RCSI1 can be increased. Making the IS1 resolution larger than the IS2 resolution is implemented by the bit assignment shift described in FIG. 17. In the example of FIG. 18, the RCSI1 minimum potential difference is 1.37 mV, and the RCSI2 minimum potential difference is 10.9 mV. The potential differences are sufficiently large because the operational amplifier OPF performs the amplification with a higher accuracy gain. Accordingly, the first charging current ICH1 and the second charging current ICH2 can be realized to have a higher-accuracy resolution.

The parameters shown in FIG. 18 are merely examples, and the parameters of the first charging circuit 110, the second charging circuit 120, and the current source circuit 140 are not limited to the parameters shown in FIG. 18.

In the embodiment described above, the circuit device 100 includes the current source circuit 140, the first charging circuit 110, the second charging circuit 120, and the control circuit 160. The first charging circuit 110 supplies, based on an output current of the current source circuit 140, the first charging current ICH1 of a constant current as the charging current IBAT to the charging node NBAT. The second charging circuit 120 supplies, based on an output current of the current source circuit 140, the second charging current ICH2 of a constant current larger than the first charging current ICH1 to the charging node NBAT as the charging current IBAT. The control circuit 160 performs, based on the current setting value INDA indicating a current value of the charging current IBAT, setting value output processing of outputting the first setting value STV1 for setting the current value of the first charging current ICH1 and the second setting value STV2 for setting the current value of the second charging current ICH2. The control circuit 160 controls, when the current setting value INDA is in the first current range, the first current mode in which the first charging current ICH1 of a current value indicated by the first setting value STV1 is supplied from the first charging circuit 110 to the charging node NBAT. The control circuit 160 performs, when the current setting value INDA is in the second current range on a current side higher than the first current range, control to supply the second charging current ICH2 of a current value indicated by the second setting value STV2 from the second charging circuit 120 to the charging node NBAT. In the setting value output processing, the control circuit 160 performs at least one of the first correction and the second correction. In the first correction, the control circuit 160 corrects the first conversion characteristic of the first charging current ICH1 with respect to the current setting value INDA by correcting the first setting value STV1. In the second correction, the control circuit 160 corrects the second conversion characteristic of the second charging current ICH2 with respect to the current setting value INDA by correcting the second setting value STV2.

According to the embodiment, when the current setting value INDA is in the second current range, the second charging circuit 120 is switched to perform the charging with the second charging current ICH2 larger than the first charging current ICH1. Accordingly, a large charging current is implemented. By switching between the first charging circuit 110 and the second charging circuit 120 according to the current setting value INDA of the charging current IBAT, an optimum constant current charging circuit can be designed according to the current value of the charging current IBAT. Accordingly, an increase in a circuit scale, a decrease in the resolution of the charging current, and a decrease in power efficiency can be prevented while implementing the large charging current.

According to the embodiment, at least one of the first correction for the first setting value STV1 and the second correction for the second setting value STV2 is performed, thereby correcting at least one of the first conversion characteristic from the current setting value INDA to the first charging current ICH1 and the second conversion characteristic from the current setting value INDA to the second charging current ICH2. Accordingly, a characteristic difference between the first conversion characteristic from the current setting value INDA to the first charging current ICH1 and the second conversion characteristic from the current setting value INDA to the second charging current ICH2 is reduced.

In the embodiment, the control circuit 160 performs at least one of the offset correction and the slope correction as at least one of the first correction and the second correction. In the offset correction, the control circuit 160 reduces the offset difference between the first conversion characteristic and the second conversion characteristic by the offset correction for at least one of the first setting value STV1 and the second setting value STV2. In the slope correction, the control circuit 160 brings the slopes of the first conversion characteristic and the second conversion characteristic closer to each other by the slope correction for at least one of the first setting value STV1 and the second setting value STV2.

According to the embodiment, at least one of the offset difference and the slope difference between the first conversion characteristic from the current setting value INDA to the first charging current ICH1 and the second conversion characteristic from the current setting value INDA to the second charging current ICH2 is reduced. Accordingly, the characteristic difference between the first conversion characteristic and the second conversion characteristic is reduced.

In the embodiment, the circuit device 100 includes the storage unit 170. The storage unit 170 stores the first slope correction value GA1 and the first offset correction value OF1 for correcting the first conversion characteristic, and the second slope correction value GA2 and the second offset correction value OF2 for correcting the second conversion characteristic. The control circuit 160 corrects the first conversion characteristic by performing the first correction of calculating the first setting value STV1 based on the first slope correction value GA1, the first offset correction value OF1, and the current setting value INDA. The control circuit 160 corrects the second conversion characteristic by performing the second correction of calculating the second setting value STV2 based on the second slope correction value GA2, the second offset correction value OF2, and the current setting value INDA.

According to the embodiment, the current value of the first charging current ICH1 is controlled based on the first setting value STV1 corrected by the first slope correction value GA1 and the first offset correction value OF1. Accordingly, the first conversion characteristic from the current setting value INDA to the first charging current ICH1 is corrected. Further, the current value of the second charging current ICH2 is controlled based on the second setting value STV2 corrected by the second slope correction value GA2 and the second offset correction value OF2. Accordingly, the second conversion characteristic from the current setting value INDA to the second charging current ICH2 is corrected.

In the embodiment, the control circuit 160 calculates the first setting value STV1 based on STV1=GA1×INDA+OF1 and calculates the second setting value STV2 based on STV2=GA2×INDA+OF2.

According to the embodiment, a slope of the first setting value STV1 is corrected by the first slope correction value GA1, and an offset of the first setting value STV1 is corrected by the first offset correction value OF1. Further, a slope of the second setting value STV2 is corrected by the second slope correction value GA2, and an offset of the second setting value STV2 is corrected by the second offset correction value OF2. Accordingly, the offset difference and the slope difference between the first conversion characteristic from the current setting value INDA to the first charging current ICH1 and the second conversion characteristic from the current setting value INDA to the second charging current ICH2 are reduced.

In the embodiment, the storage unit 170 stores the threshold THR corresponding to a boundary between the first current range and the second current range. When the current setting value INDA is smaller than the threshold THR, the control circuit 160 controls the first current mode based on the first setting value STV1. When the current setting value INDA is larger than the threshold THR, the control circuit 160 controls the second current mode based on the second setting value STV2.

According to the embodiment, the threshold THR corresponding to the boundary between the first current range and the second current range can be changed by storing the desired threshold THR in the storage unit 170. Accordingly, the first charging mode and the second charging mode can be switched by the optimum threshold THR. For example, as shown in FIG. 14, when the characteristic of the first charging current ICH1 or the characteristic of the second charging current ICH2 has the nonlinear region, the first charging mode and the second charging mode can be switched by the optimum threshold THR while avoiding the nonlinear region.

In the embodiment, the storage unit 170 may be a nonvolatile memory.

According to the embodiment, the threshold and the correction parameter are written into the storage unit 170 at the time of manufacturing the circuit device 100 or the electronic apparatus 200. Accordingly, an optimum threshold and an optimum correction parameter are obtained by being measured in advance or by simulation processing in advance, and the threshold and the correction parameter can be written into the nonvolatile memory.

In the embodiment, in the first current mode, the current source circuit 140 supplies the first current IS1 as the output current to the first charging circuit 110 based on the first setting value STV1. The first charging circuit 110 supplies the first charging current ICH1 by amplifying the first current IS1 with the first gain. In the second current mode, the current source circuit 140 supplies the second current IS2 as the output current to the second charging circuit 120 based on the second setting value STV2. The second charging circuit 120 supplies the second charging current ICH2 by amplifying the second current IS2 with the second gain larger than the first gain.

According to the embodiment, since the second gain in the second current mode is larger than the first gain in the first current mode, the second charging current larger than the first charging current can be generated in the second current mode. Further, as shown in FIG. 18, (ICH1 resolution)=(ICH2 resolution) is true, (ICH1 resolution)=(IS1 resolution)×(first gain) is true, and (RCSI1 minimum potential difference)=RCSI1×(IS1 resolution) is true. Since the first gain is smaller than the second gain, the IS1 resolution can be increased, and the RCSI1 minimum potential difference can be increased. Accordingly, the resolution of the first charging current ICH1 can be more accurate. Although the IS2 resolution is smaller than the IS1 resolution, the RCSI2 minimum potential difference=RCSI2×IS2min is obtained by separating the first charging circuit 110 and the second charging circuit 120. Accordingly, a value of the resolution of the second charging current ICH2 becomes the same as a value of the resolution of the first charging current ICH1, and the resolution of the second charging current ICH2 can be more accurate similarly to the first charging current ICH1.

In the embodiment, for example, the first gain may be set according to a ratio between a first metal resistor and a first poly resistor, and the second gain may be set according to a ratio between a second metal resistor and a second poly resistor. Specifically, the resistor RRSS1 of the first charging circuit 110 is the first metal resistor, and the resistor RCSI1 of the first charging circuit 110 is the first poly resistor. The resistor RRSS2 of the second charging circuit 120 is the second metal resistor, and the resistor RCSI2 of the second charging circuit 120 is the second poly resistor. However, types of the resistors are not limited thereto.

According to the embodiment, a resistance serving as a denominator of a gain is a metal resistance, and thus the resistance can be set to a small resistance value. Accordingly, the gain can be increased. At this time, since the gain is easily affected by the parasitic resistance, the characteristic difference between the first conversion characteristic and the second conversion characteristic occurs easily. According to the embodiment, by performing at least one of the first correction and the second correction, the characteristic difference between the first conversion characteristic and the second conversion characteristic is reduced.

In the embodiment, the current source circuit 140 includes the first to n-th current sources that output first to n-th constant currents whose current values are binarily weighted, and the switch circuit 145. In the first current mode, the control circuit 160 outputs, based on the first setting value STV1, first to n-th control bit signals QDA[0] to QDA[n-l] of the current source control value QDA for controlling the first to n-th current sources. The switch circuit 145 supplies a current from a current source selected based on the first to n-th control bit signals QDA[0] to QDA[n−1] among the first to n-th current sources to the first charging circuit 110 as the first current IS1. In the second current mode, the control circuit 160 outputs the first to n-th control bit signals QDA[0] to QDA[n−1] based on the second setting value STV2. The switch circuit 145 supplies a current from a current source selected based on the first to n-th control bit signals QDA[0] to QDA[n−1] among the first to n-th current sources to the second charging circuit 120 as the second current IS2.

In the examples of FIGS. 16 to 18, n=13, but n may be an integer of 2 or more.

According to the embodiment, in the first current mode, the current value of the first charging current ICH1 is set by setting the current value of the first current IS1 based on the first setting value STV1 corrected by the first correction. In the second current mode, the current value of the second charging current ICH2 is set by setting the current value of the second current IS2 based on the second setting value STV2 corrected by the second correction.

In the embodiment, in the second current mode, the control circuit 160 outputs (i+1)-th to (i+n)-th bit signals STV2[i] to STV2[i+n−1] among the bit signals of the second setting value STV2 as the first to n-th control bit signals QDA[0] to QDA[n−1]. In the first current mode, the control circuit 160 outputs (i+1−k)-th to (i−k+n)-th bit signals STV1[i−k] to STV1[i−k+n−1] among the bit signals of the first setting value STV1 as the first to n-th control bit signals QDA[0] to QDA[n−1].

Although n=13, i=8, and k=3 in the examples of FIGS. 16 to 18, n may be an integer of 2 or more, i may be an integer of 1 or more, and k may be an integer of 1 or more and i or less. The current source circuit 140 includes n current sources whose current values are binarily weighted. The (n-k) current sources with the highest weight among the n current sources correspond to a current source control value QDA[n−1:k] in the first current mode. In FIG. 17, for example, the number of current sources corresponding to QDA[12:3] is 10. This is because the bit corresponding to INDA[0] which is the LSB of the current setting value is QDA[3]. A current source corresponding to QDA[k−1:0] at a lower bit than the LSB of the current setting value may be made inactive regardless of the bit so as not to operate or may be made active regardless of the bit. Further, QDA[k−1:0] may be supplied to the current source at the lower bit than the LSB of the current setting value for control. In FIG. 17, QDA[k−1:0] is QDA[2:0].

According to the embodiment, as shown in FIGS. 17 and 18, the resolution of the first current IS1 corresponding to the LSB of the current setting value INDA and the resolution of the second current IS2 corresponding to the LSB of the current setting value INDA are different. In the embodiment, since the difference in the resolution can be absorbed by the difference between the first gain of the first charging circuit 110 and the second gain of the second charging circuit 120, the resolution of the first charging current ICH1 and the resolution of the second charging current ICH2 corresponding to the LSB of the current setting value INDA can be set substantially equal.

In addition, according to the embodiment, as shown in FIG. 18, since the first gain is smaller than the second gain, the resolution of the first current IS1 can be made larger than the resolution of the second current IS2. The difference in the resolution is implemented by the bit assignment from the second setting value STV2 to the current source control value QDA and the bit assignment from the first setting value STV1 to the current source control value QDA being different by k bits. Since the minimum potential difference of the resistor RCSI1 related to the first gain can be increased by increasing the resolution of the first current IS1, a sufficiently large potential difference for the operational amplifier OPF to perform the amplification at a more accurate gain can be ensured. Accordingly, the first charging current ICH1 and the second charging current ICH2 can be realized to have a higher-accuracy resolution.

### 2. Second Embodiment

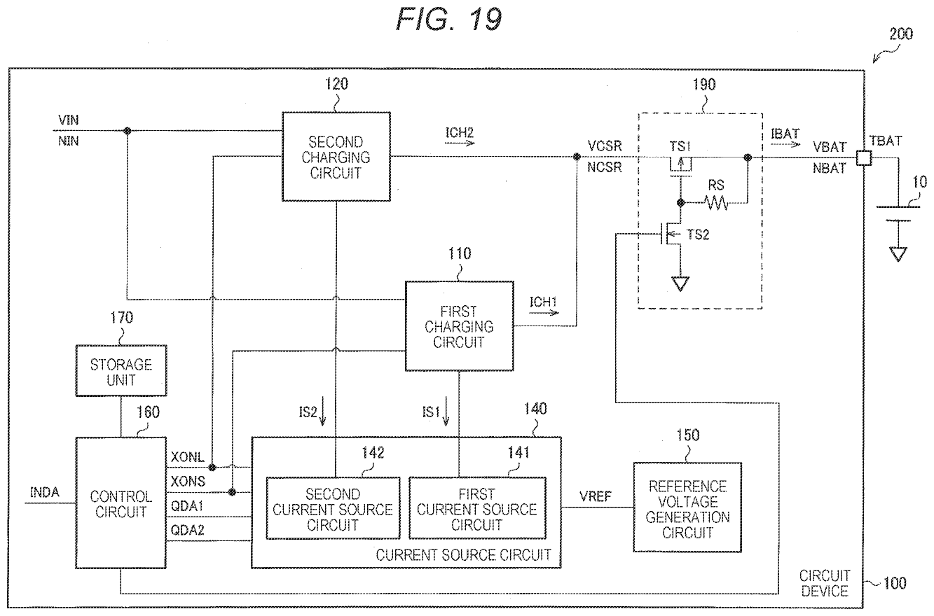

FIG. 19 shows a configuration example of the circuit device 100 and the electronic apparatus 200 including the circuit device 100 according to a second embodiment. The second embodiment is different from the first embodiment in a configuration of the current source circuit 140. The first correction, the second correction, and a threshold setting method are the same as those in the first embodiment. The same components as those described above are denoted by the same reference numerals, and the description thereof will be appropriately omitted.

The control circuit 160 performs the first correction for the current setting value INDA, and outputs a result of the correction as a first current source control value QDA1 to the current source circuit 140. Further, the control circuit 160 performs the second correction for the current setting value INDA, and outputs a result of the correction as a second current source control value QDA2 to the current source circuit 140. However, only one of the first correction and the second correction may be performed, or both may be performed.

The current source circuit 140 includes a first current source circuit 141 and the second current source circuit 142. The first current source circuit 141 generates the first current IS1 of a current value set based on the first current source control value QDA1, and supplies the first current IS1 to the first charging circuit 110. The second current source circuit 142 generates the second current IS2 of a current value set based on the second current source control value QDA2, and supplies the second current IS2 to the second charging circuit 120.

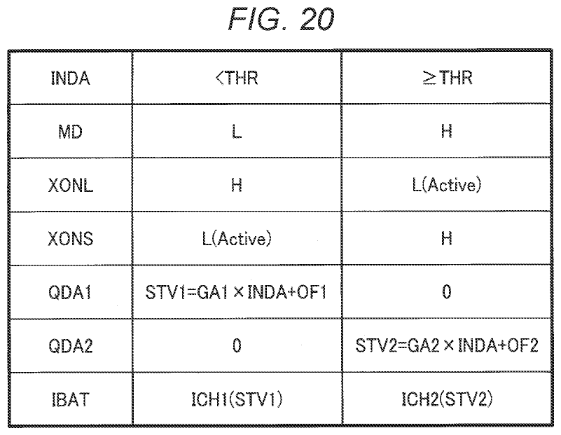

FIG. 20 is an operation explanatory diagram of the control circuit 160 according to the second embodiment. Hereinafter, operations of the threshold determination unit 163 and the setting value output unit 164 included in the control circuit 160 will be described. The operation of the threshold determination unit 163 is the same as that in the first embodiment.

When the mode control signal MD is at a low level, the setting value output unit 164 outputs the first current source control value QDA1 based on the first setting value STV1, and sets the second current source control value QDA2 to 0. The setting value output unit 164 outputs the current source control value QDA to the current source circuit 140 in FIG. 3, whereas the setting value output unit 164 outputs the first current source control value QDA1 and the second current source control value QDA2 to the current source circuit 140 in the embodiment. Accordingly, the charging current IBAT=ICH1 in the first charging mode is controlled by the first setting value STV1 corrected by the first correction. When the mode control signal MD is at a high level, the setting value output unit 164 outputs the second current source control value QDA2 based on the second setting value STV2, and sets the first current source control value QDA1 to 0. Accordingly, the charging current IBAT=ICH2 in the second charging mode is controlled by the second setting value STV2 corrected by the second correction.

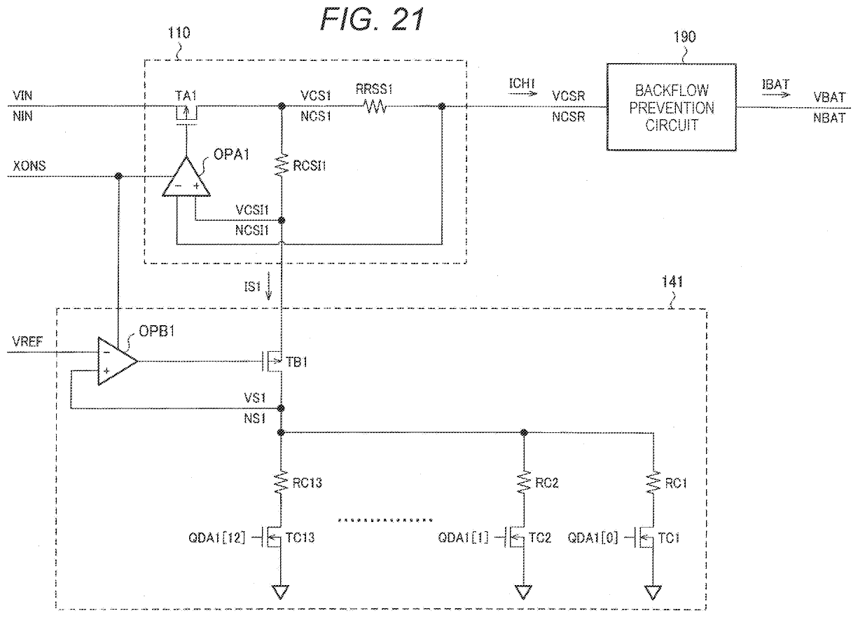

FIG. 21 shows a detailed configuration example of the first charging circuit 110 and the first current source circuit 141. A configuration of the first charging circuit 110 is the same as that of the first embodiment.

The first current source circuit 141 includes an operational amplifier OPB1, a P-type transistor TB1, resistors RC1 to RC13, and N-type transistors TC1 to TC13.

A source of the P-type transistor TB1 is coupled to the node NCSI1, and a drain of the P-type transistor TB1 is coupled to a node NS1. The reference voltage VREF is input to an inverting input terminal of the operational amplifier OPB1. A non-inverting input terminal of the operational amplifier OPB1 is coupled to the node NS1, and an output node of the operational amplifier OPB1 is coupled to a gate of the P-type transistor TB1. One end of the resistor RC1 is coupled to the node NS1, and the other end of the resistor RC1 is coupled to a drain of the N-type transistor TC1. A source of the N-type transistor TC1 is coupled to a ground node. Similarly, one end of each of the resistors RC2 to RC13 is coupled to the node NS1, and the other end of each of the resistors RC2 to RC13 is coupled to a drain of a respective one of the N-type transistors TC2 to TC13. A source of each of the N-type transistors TC2 to TC13 is coupled to the ground node. A control bit signal QDA1[0] of the first current source control value QDA1 is input to a gate of the N-type transistor TC1. Similarly, control bit signals QDA1[1] to QDA1[12] of the first current source control value QDA1 are input to gates of the N-type transistors TC2 to TC13.

The operational amplifier OPB1 is enabled when the first enable signal XONS is active. Accordingly, a voltage of the node NS1 is VS1=VREF. The resistor RC1 and the N-type transistor TC1 are referred to as a first current source of the first current source circuit 141. When the control bit signal QDA[0] of the first current source control value QDA1 is 1, the N-type transistor TC1 is turned on, and the first current source causes a current of VREF/RC1 to flow. Similarly, the resistors RC2 to RC13 and the N-type transistors TC2 to TC13 are referred to as second to thirteenth current sources of the first current source circuit 141. When the control bit signals QDA1[1] to QDA1[12] of the first current source control value QDA1 are 1, the N-type transistors TC2 to TC13 are turned on, and the second to thirteenth current sources cause currents of VREF/RC2 to VREF/RC13 to flow. The first current IS1 flowing through the P-type transistor TB1 is a sum of currents flowing from the current sources corresponding to the control bit signal which is 1 among the control bit signals QDA1[0] to QDA1[12] of the first current source control value QDA1. The number of current sources included in the first current source circuit 141 is not limited to 13, and may be m. m is an integer of 2 or more and n or less.

When the first enable signal XONS is inactive, the operational amplifiers OPAL and OPB1 are disabled. At this time, the P-type transistors TA1 and TB1 are turned off, and the first current IS1 and the first charging current ICH1 do not flow.

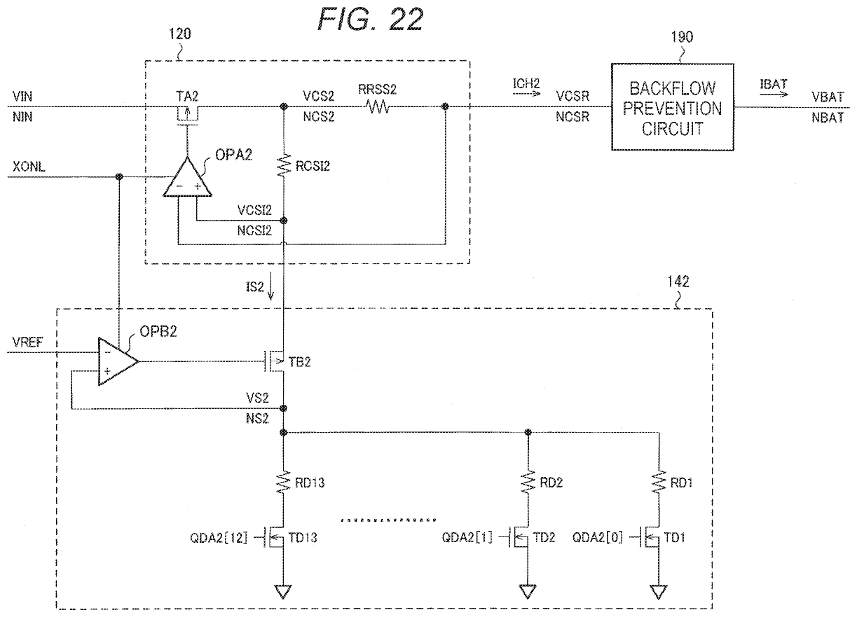

FIG. 22 shows a detailed configuration example of the second charging circuit 120 and the second current source circuit 142. A configuration of the second charging circuit 120 is the same as that of the first embodiment.

The second current source circuit 142 includes an operational amplifier OPB2, a P-type transistor TB2, resistors RD1 to RD13, and N-type transistors TD1 to TD13.

A source of the P-type transistor TB2 is coupled to the node NCSI2, and a drain of the P-type transistor TB2 is coupled to a node NS2. The reference voltage VREF is input to an inverting input terminal of the operational amplifier OPB2. A non-inverting input terminal of the operational amplifier OPB2 is coupled to the node NS2, and an output node of the operational amplifier OPB2 is coupled to a gate of the P-type transistor TB2. One end of the resistor RD1 is coupled to the node NS2, and the other end of the resistor RD1 is coupled to a drain of the N-type transistor TD1. A source of the N-type transistor TD1 is coupled to a ground node. Similarly, one end of each of the resistors RD2 to RD13 is coupled to the node NS2, and the other end of each of the resistors RD2 to RD13 is coupled to a drain of a respective one of the N-type transistors TD2 to TD13. A source of each of the N-type transistors TD2 to TD13 is coupled to the ground node. A control bit signal QDA2[0] of the second current source control value QDA2 is input to a gate of the N-type transistor TD1. Control bit signals QDA2[1] to QDA2[12] of the second current source control value QDA2 are input to gates of the N-type transistors TD2 to TD13.

The operational amplifier OPB2 is enabled when the second enable signal XONL is active. Accordingly, a voltage of the node NS2 is VS2=VREF. The resistor RD1 and the N-type transistor TD1 are referred to as a first current source of the second current source circuit 142. When the control bit signal QDA2[0] of the second current source control value QDA2 is 1, the N-type transistor TD1 is turned on, and the first current source causes a current of VREF/RD1 to flow. Similarly, the resistors RD2 to RD13 and the N-type transistors TD2 to TD13 are referred to as second to thirteenth current sources of the second current source circuit 142. When the control bit signals QDA2[1] to QDA2[12] of the second current source control value QDA2 are 1, the N-type transistors TD2 to TD13 are turned on, and the second to thirteenth current sources cause currents of VREF/RD2 to VREF/RD13 to flow. The second current IS2 flowing through the P-type transistor TB2 is a sum of currents flowing from the current sources corresponding to the control bit signal which is 1 among the control bit signals QDA2[0] to QDA2[12] of the second current source control value QDA2. The number of current sources included in the second current source circuit 142 is not limited to 13, and may be n.

When the second enable signal XONL is inactive, the operational amplifiers OPA2 and OPB2 are disabled. At this time, the P-type transistors TA2 and TB2 are turned off, and the second current IS2 and the second charging current ICH2 do not flow.

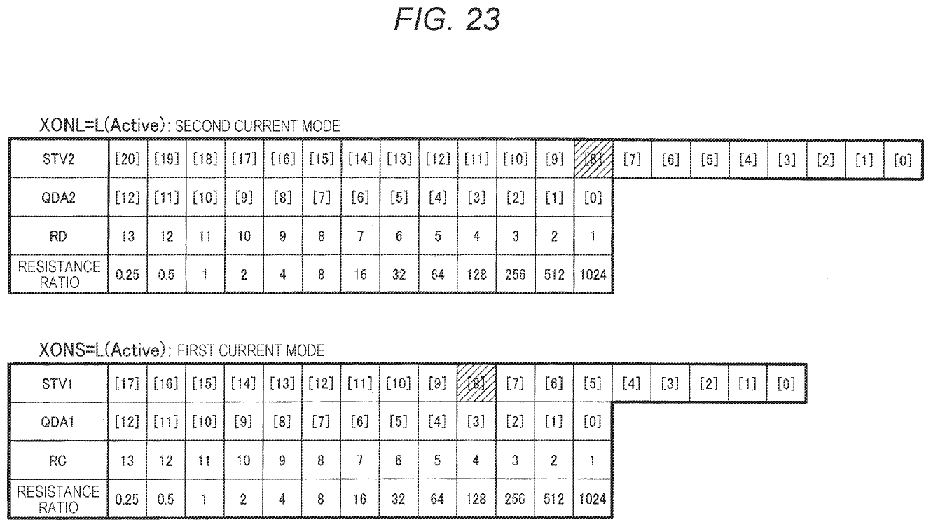

FIG. 23 is a diagram showing resistance ratios and operations of the first current source circuit 141 and the second current source circuit 142.

In the first current source circuit 141, a resistance ratio of the resistors RC1 to RC13 for determining a current ratio of the first to thirteenth current sources is RC13:RC12 . . . :RC2:RC1=0.25:0.5 . . . :512:1024. Since a reciprocal ratio thereof is the current ratio, the currents flowing from the first to thirteenth current sources are binarily weighted. In a case of the first current mode, that is, when the first enable signal XONS is at a low level, the setting value output unit 164 assigns upper 13 bits of STV1[17:0] to the first current source control value QDA1, and outputs QDA1[12:0]=STV1[17:5] to the first current source circuit 141.

In the second current source circuit 142, a resistance ratio of the resistors RD1 to RD13 for determining a current ratio of the first to thirteenth current sources is RD13:RD12 . . . :RD2:RD1=0.25:0.5 . . . :512:1024. Since a reciprocal ratio thereof is the current ratio, the currents flowing from the first to thirteenth current sources are binarily weighted. In a case of the second current mode, that is, when the second enable signal XONL is at a low level, the setting value output unit 164 assigns upper 13 bits of STV2[20:0] to the second current source control value QDA2, and outputs QDA2[12:0]=STV2[20:8] to the second current source circuit 142.

Comparing FIG. 23 of the second embodiment with FIG. 17 of the first embodiment, it is understood that the same operation as that of the first embodiment is substantially implemented in the second embodiment.

In the embodiment described above, the current source circuit 140 includes the first current source circuit 141 and the second current source circuit 142. The first current source circuit 141 includes m current sources that output m constant currents whose current values are binarily weighted. The second current source circuit 142 includes n current sources that output n constant currents whose current values are binarily weighted. The control circuit 160 outputs, based on the first setting value STV1, the m-bit first current source control value QDA1 for controlling the m current sources of the first current source circuit 141, and outputs, based on the second setting value STV2, the n-bit second current source control value QDA2 for controlling the n current sources of the second current source circuit 142. The first current source circuit 141 supplies a current from a current source selected based on the first current source control value QDA1 among the m current sources to the first charging circuit 110 as the first current IS1. The second current source circuit 142 supplies a current from a current source selected based on the second current source control value QDA2 among the n current sources to the second charging circuit 120 as the second current IS2.

Although m=n=13 in the examples of FIGS. 21 to 23, m may be an integer of 2 or more, n may be an integer of m or more, and n may not be equal to m.

According to the embodiment, in the first current mode, the current value of the first charging current ICH1 is set by setting the current value of the first current IS1 based on the first setting value STV1 corrected by the first correction. In the second current mode, the current value of the second charging current ICH2 is set by setting the current value of the second current IS2 based on the second setting value STV2 corrected by the second correction.

In the embodiment, the control circuit 160 outputs (i+1)-th to (i+n)-th bit signals STV2[i] to STV2[i+n−1] among the bit signals of the second setting value STV2 as the n-bit second current source control value QDA2[n−1:0]. The control circuit 160 outputs (i+1−k)-th to (i−k+m)-th bit signals STV1[i−k] to STV1[i−k+m−1] among the bit signals of the first setting value STV1 as the m-bit first current source control value QDA1[m−1:0].

In the example of FIGS. 21 to 23, m=n=13, i=8, and k=3, but m may be an integer of 2 or more, n may be an integer of m or more, n may not be equal to m, i may be an integer of 1 or more, and k may be an integer of 1 or more and i or less.

According to the embodiment, similarly to the first embodiment, a resolution of the first current IS1 corresponding to the LSB of the current setting value INDA and a resolution of the second current IS2 corresponding to the LSB of the current setting value INDA are different. In the embodiment, since a difference in the resolution can be absorbed by a difference between a first gain of the first charging circuit 110 and a second gain of the second charging circuit 120, the resolution of the first charging current ICH1 and the resolution of the second charging current ICH2 corresponding to the LSB of the current setting value INDA can be set substantially equal.

According to the embodiment, similarly to the first embodiment, since the first gain is smaller than the second gain, the resolution of the first current IS1 can be made larger than the resolution of the second current IS2. The difference in the resolution is implemented by the bit assignment from the second setting value STV2 to the second current source control value QDA2 and the bit assignment from the first setting value STV1 to the first current source control value QDA1 being different by k bits. Since a minimum potential difference of the resistor RCSI1 related to the first gain can be increased by increasing the resolution of the first current IS1, and a sufficiently large potential difference for the operational amplifier OPF to perform the amplification at a more accurate gain can be ensured. Accordingly, the first charging current ICH1 and the second charging current ICH2 can be realized to have a higher-accuracy resolution.

The circuit device according to the embodiment described above includes a current source circuit, a first charging circuit, a second charging circuit, and a control circuit. The first charging circuit supplies, based on an output current of the current source circuit, a first charging current of a constant current as a charging current to a charging node. The second charging circuit supplies, based on the output current of the current source circuit, a second charging current of a constant current larger than the first charging current as the charging current to the charging node. The control circuit performs, based on a current setting value indicating a current value of the charging current, setting value output processing of outputting a first setting value for setting a current value of the first charging current and a second setting value for setting a current value of the second charging current. The control circuit controls, when the current setting value is in a first current range, a first current mode in which the first charging current of a current value indicated by the first setting value is supplied from the first charging circuit to the charging node. The control circuit controls, when the current setting value is in a second current range on a current side higher than the first current range, a second current mode in which a second charging current of a current value indicated by the second setting value is supplied from the second charging circuit to the charging node. In the setting value output processing, the control circuit performs at least one of first correction for correcting a first conversion characteristic of the first charging current with respect to the current setting value by correcting the first setting value and second correction for correcting a second conversion characteristic of the second charging current with respect to the current setting value by correcting the second setting value.

According to the embodiment, by switching between the first charging circuit and the second charging circuit according to the current setting value of the charging current, an optimum constant current charging circuit can be designed according to the current value of the charging current. Accordingly, an increase in a circuit scale, a decrease in the resolution of the charging current, and a decrease in power efficiency can be prevented while implementing a large charging current. According to the embodiment, at least one of the first correction for the first setting value and the second correction for the second setting value is performed, thereby correcting at least one of the first conversion characteristic from the current setting value to the first charging current and the second conversion characteristic from the current setting value to the second charging current. Accordingly, a characteristic difference between the first conversion characteristic and the second conversion characteristic is reduced.

In the embodiment, the control circuit may perform at least one of offset correction and slope correction as at least one of the first correction and the second correction. In the offset correction, the control circuit may reduce an offset difference between the first conversion characteristic and the second conversion characteristic by the offset correction for at least one of the first setting value and the second setting value. In the slope correction, the control circuit may bring slopes of the first conversion characteristic and the second conversion characteristic closer to each other by the slope correction for at least one of the first setting value and the second setting value.

According to the embodiment, at least one of the offset difference and the slope difference between the first conversion characteristic from the current setting value to the first charging current and the second conversion characteristic from the current setting value to the second charging current is reduced. Accordingly, the characteristic difference between the first conversion characteristic and the second conversion characteristic is reduced.

In the embodiment, the circuit device may include a storage unit. The storage unit may store a first slope correction value and a first offset correction value for correcting the first conversion characteristic, and a second slope correction value and a second offset correction value for correcting the second conversion characteristic. The control circuit may correct the first conversion characteristic by performing the first correction of calculating the first setting value based on the first slope correction value, the first offset correction value, and the current setting value. The control circuit may correct the second conversion characteristic by performing the second correction of calculating the second setting value based on the second slope correction value, the second offset correction value, and the current setting value.

According to the embodiment, the current value of the first charging current is controlled based on the first setting value corrected by the first slope correction value and the first offset correction value. Accordingly, the first conversion characteristic from the current setting value to the first charging current is corrected. Further, the current value of the second charging current is controlled based on the second setting value corrected by the second slope correction value and the second offset correction value. Accordingly, the second conversion characteristic from the current setting value to the second charging current is corrected.

In the embodiment, the current setting value may be INDA, the first slope correction value may be GA1, the first offset correction value may be OF1, the second slope correction value may be GA2, and the first offset correction value may be OF2. At this time, the control circuit may calculate the first setting value STV1 and the second setting value STV2 based on STV1=GA1×INDA+OF1 and STV2=GA2×INDA+OF2.

According to the embodiment, a slope of the first setting value is corrected by the first slope correction value, and an offset of the first setting value is corrected by the first offset correction value. Further, a slope of the second setting value is corrected by the second slope correction value, and an offset of the second setting value is corrected by the second offset correction value. Accordingly, the offset difference and the slope difference between the first conversion characteristic from the current setting value to the first charging current and the second conversion characteristic from the current setting value to the second charging current are reduced.

In the embodiment, the storage unit may store a threshold corresponding to a boundary between the first current range and the second current range. The control circuit may control, when the current setting value is smaller than the threshold, the first current mode based on the first setting value. The control circuit may control, when the current setting value is larger than the threshold, the second current mode based on the second setting value.

According to the embodiment, the threshold corresponding to the boundary between the first current range and the second current range can be changed by storing a desired threshold in the storage unit. Accordingly, the first charging mode and the second charging mode can be switched by an optimum threshold. For example, when a characteristic of the first charging current or a characteristic of the second charging current has a nonlinear region, the first charging mode and the second charging mode can be switched by the optimum threshold while avoiding the nonlinear region.

In the embodiment, the storage unit may be a nonvolatile memory.

According to the embodiment, the threshold and a correction parameter are written into the storage unit at a time of manufacturing the circuit device or an electronic apparatus including the circuit device. Accordingly, an optimum threshold and an optimum correction parameter are obtained by being measured in advance or by simulation processing in advance, and the threshold and the correction parameter can be written into the nonvolatile memory.

In the embodiment, in the first current mode, the current source circuit may supply a first current as the output current to the first charging circuit based on the first setting value, and the first charging circuit may supply the first charging current by amplifying the first current with a first gain. In the second current mode, the current source circuit may supply a second current as the output current to the second charging circuit based on the second setting value, and the second charging circuit may supply the second charging current by amplifying the second current with a second gain larger than the first gain.

According to the embodiment, since the second gain in the second current mode is larger than the first gain in the first current mode, the second charging current larger than the first charging current can be generated in the second current mode. In addition, since the first gain is smaller than the second gain, a resolution of the first current can be increased. Accordingly, a resolution of the first charging current can be more accurate. Although a resolution of the second current is smaller than the resolution of the first current, the resolution of the second charging current can be more accurate by separating the first charging circuit and the second charging circuit.

In the embodiment, the first gain may be set according to a ratio between a first metal resistor and a first poly resistor. The second gain may be set according to a ratio between a second metal resistor and a second poly resistor.

According to the embodiment, a resistance serving as a denominator of a gain is a metal resistance, and thus the resistance can be set to a small resistance value. Accordingly, the gain can be increased. At this time, since the gain is easily affected by a parasitic resistance, the characteristic difference between the first conversion characteristic and the second conversion characteristic occurs easily. According to the embodiment, by performing at least one of the first correction and the second correction, the characteristic difference between the first conversion characteristic and the second conversion characteristic is reduced.

In the embodiment, the current source circuit may include first to n-th current sources that output first to n-th constant currents whose current values are binarily weighted, and a switch circuit. n is an integer of 2 or more. In the first current mode, the control circuit may output, based on the first setting value, first to n-th control bit signals of a current source control value for controlling the first to n-th current sources. The switch circuit may supply a current from a current source selected based on the first to n-th control bit signals among the first to n-th current sources to the first charging circuit as the first current. In the second current mode, the control circuit may output the first to n-th control bit signals based on the second setting value. The switch circuit may supply a current from a current source selected based on the first to n-th control bit signals among the first to n-th current sources to the second charging circuit as the second current.

According to the embodiment, in the first current mode, the current value of the first charging current is set by setting the current value of the first current based on the first setting value corrected by the first correction. In the second current mode, the current value of the second charging current is set by setting the current value of the second current based on the second setting value corrected by the second correction.

In the embodiment, in the second current mode, the control circuit may output (i+1)-th to (i+n)-th bit signals among the bit signals of the second setting value as the first to n-th control bit signals. i is an integer of 1 or more. In the first current mode, the control circuit may output (i+1−k)-th to (i−k+n)-th bit signals among the bit signals of the first setting value as the first to n-th control bit signals. k is an integer of 1 or more and i or less.

According to the embodiment, the resolution of the first current and the resolution of the second current corresponding to the LSB of the current setting value are different. In the embodiment, since the difference in the resolution can be absorbed by the difference between the first gain of the first charging circuit and the second gain of the second charging circuit, the resolution of the first charging current and the resolution of the second charging current corresponding to the LSB of the current setting value can be set substantially equal.

In the embodiment, the current source circuit may include a first current source circuit including m current sources that output m constant currents whose current values are binarily weighted, and a second current source circuit including n current sources that output n constant currents whose current values are binarily weighted. m is an integer of 2 or more. n is an integer of m or more. The control circuit may output, based on the first setting value, an m-bit first current source control value for controlling the m current sources of the first current source circuit, and may output, based on the second setting value, an n-bit second current source control value for controlling the n current sources of the second current source circuit. The first current source circuit may supply a current from a current source selected based on the first current source control value among the m current sources to the first charging circuit as the first current. The second current source circuit may supply a current from a current source selected based on the second current source control value among the n current sources to the second charging circuit as the second current.

According to the embodiment, in the first current mode, the current value of the first charging current is set by setting the current value of the first current based on the first setting value corrected by the first correction. In the second current mode, the current value of the second charging current is set by setting the current value of the second current based on the second setting value corrected by the second correction.

In the embodiment, the control circuit may output the (i+1)-th to (i+n)-th bit signals among the bit signals of the second setting value as the n-bit second current source control value. i is an integer of 1 or more. The control circuit may output the (i+1−k)-th to (i−k+m)-th bit signals among the bit signals of the first setting value as the m-bit first current source control value. k is an integer of 1 or more and i or less. m is an integer of 2 or more and n or less.

According to the embodiment, the resolution of the first current and the resolution of the second current corresponding to the LSB of the current setting value are different. In the embodiment, since the difference in the resolution can be absorbed by the difference between the first gain of the first charging circuit and the second gain of the second charging circuit, the resolution of the first charging current and the resolution of the second charging current corresponding to the LSB of the current setting value can be set substantially equal.

Further, an electronic apparatus according to the embodiment includes any one of the circuit devices described above and a battery coupled to the charging node.

Although the embodiments have been described in detail above, it will be easily understood by those skilled in the art that many modifications can be made without substantially departing from the novel matters and effects of the present disclosure. Therefore, all such modifications are within the scope of the present disclosure. For example, a term cited with a different term having a broader meaning or the same meaning at least once in the description or the drawings can be replaced with a different term at any place in the description or the drawings. All combinations of the embodiments and the modifications are also included in the scope of the present disclosure. Configurations and operations of the circuit device, a battery, the electronic apparatus, and the like are not limited to those described in the embodiments, and various modifications can be made.

What is claimed is:

1. A circuit device comprising:
a current source circuit;
a first charging circuit configured to supply, based on an output current of the current source circuit, a first charging current of a constant current as a charging current to a charging node;
a second charging circuit configured to supply, based on the output current of the current source circuit, a second charging current of a constant current larger than the first charging current as the charging current to the charging node; and
a control circuit configured to perform, based on a current setting value indicating a current value of the charging current, setting value output processing of outputting a first setting value for setting a current value of the first charging current and a second setting value for setting a current value of the second charging current, wherein
the control circuit is configured to
control, when the current setting value is in a first current range, in a first current mode in which the first charging current of the current value indicated by the first setting value is supplied from the first charging circuit to the charging node,
control, when the current setting value is in a second current range on a current side higher than the first current range, in a second current mode in which the second charging current of the current value indicated by the second setting value is supplied from the second charging circuit to the charging node, and
perform, in the setting value output processing, at least one of first correction for correcting a first conversion characteristic of the first charging current with respect to the current setting value by correcting the first setting value and second correction for correcting a second conversion characteristic of the second charging current with respect to the current setting value by correcting the second setting value.

2. The circuit device according to claim 1, wherein
the control circuit is configured to
perform, as at least one of the first correction and the second correction, at least one of offset correction for reducing an offset difference between the first conversion characteristic and the second conversion characteristic by the offset correction for at least one of the first setting value and the second setting value and slope correction for bringing a slope of the first conversion characteristic and a slope of the second conversion characteristic closer to each other by the slope correction for at least one of the first setting value and the second setting value.

3. The circuit device according to claim 1, further comprising:
a storage unit configured to store a first slope correction value and a first offset correction value for correcting the first conversion characteristic and a second slope correction value and a second offset correction value for correcting the second conversion characteristic, wherein
the control circuit is configured to
correct the first conversion characteristic by performing the first correction for calculating the first setting value based on the first slope correction value, the first offset correction value, and the current setting value, and
correct the second conversion characteristic by performing the second correction for calculating the second setting value based on the second slope correction value, the second offset correction value, and the current setting value.

4. The circuit device according to claim 3, wherein
the control circuit is configured to calculate, based on
STV1=GA1×INDA+OF1 and
STV2=GA2×INDA+OF2,
a first setting value STV1 and a second setting value STV2, in which the current setting value is INDA, the first slope correction value is GA1, the first offset correction value is OF1, the second slope correction value is GA2, and the second offset correction value is OF2.

5. The circuit device according to claim 3, wherein
the storage unit is configured to
store a threshold corresponding to a boundary between the first current range and the second current range, and
the control circuit is configured to
control, when the current setting value is smaller than the threshold, in the first current mode based on the first setting value, and
control, when the current setting value is larger than the threshold, in the second current mode based on the second setting value.

6. The circuit device according to claim 3, wherein
the storage unit is a nonvolatile memory.

7. The circuit device according to claim 1, wherein
in the first current mode, the current source circuit supplies a first current as the output current to the first charging circuit based on the first setting value, and the first charging circuit supplies the first charging current by amplifying the first current with a first gain, and
in the second current mode, the current source circuit supplies a second current as the output current to the second charging circuit based on the second setting value, and the second charging circuit supplies the second charging current by amplifying the second current with a second gain larger than the first gain.

8. The circuit device according to claim 7, wherein
the first gain is set according to a ratio between a first metal resistor and a first poly resistor, and
the second gain is set according to a ratio between a second metal resistor and a second poly resistor.

9. The circuit device according to claim 7, wherein
the current source circuit includes:
first to n-th current sources configured to output first to n-th constant currents whose current values are binarily weighted, n being an integer of 2 or more; and
a switch circuit,
in the first current mode, the control circuit outputs, based on the first setting value, first to n-th control bit signals of a current source control value for controlling the first to n-th current sources, and the switch circuit supplies a current from a current source selected based on the first to n-th control bit signals among the first to n-th current sources to the first charging circuit as the first current, and
in the second current mode, the control circuit outputs the first to n-th control bit signals based on the second setting value, and the switch circuit supplies a current from a current source selected based on the first to n-th control bit signals among the first to n-th current sources to the second charging circuit as the second current.

10. The circuit device according to claim 9, wherein
the control circuit is configured to
output, in the second current mode, (i+1)-th to (i+n)-th bit signals among bit signals of the second setting value as the first to n-th control bit signals, i being an integer of 1 or more, and
output, in the first current mode, (i+1−k)-th to (i−k+n)-th bit signals among bit signals of the first setting value as the first to n-th control bit signals, k being an integer of 1 or more and i or less.

11. The circuit device according to claim 7, wherein
the current source circuit includes
a first current source circuit including m current sources configured to output m constant currents whose current values are binarily weighted, m being an integer of 2 or more, and
a second current source circuit including n current sources configured to output n constant currents whose current values are binarily weighted, n being an integer of m or more,
the control circuit is configured to
output, based on the first setting value, an m-bit first current source control value for controlling the m current sources of the first current source circuit, and output, based on the second setting value, an n-bit second current source control value for controlling the n current sources of the second current source circuit,
the first current source circuit is configured to
supply a current from a current source selected based on the first current source control value among the m current sources as the first current to the first charging circuit, and
the second current source circuit is configured to
supply a current from a current source selected based on the second current source control value among the n current sources as the second current to the second charging circuit.

12. The circuit device according to claim 11, wherein
the control circuit is configured to
output (i+1)-th to (i+n)-th bit signals among bit signals of the second setting value as the n-bit second current source control value, i being an integer of 1 or more, and
output (i+1−k)-th to (i−k+m)-th bit signals among bit signals of the first setting value as the m-bit first current source control value, k being an integer of 1 or more and i or less and m being an integer of 2 or more and n or less.

13. An electronic apparatus comprising:
the circuit device according to claim 1; and
a battery coupled to the charging node.
